(19) United States
(12) Patent Application Publication
(10) Pub. No.: US 2010/0207838 A1
(43) Pub. Date: Aug. 19, 2010

(54) Antenna structure

(75) Inventors: Ming-Chi Chiu, Taipei Hsien (TW); Sheng-Chih Sun, Taipei Hsien (TW); Wen-Kuei Lo, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/453,022

(22) Filed: Apr. 28, 2009

(30) Foreign Application Priority Data
Feb. 13, 2009 (TW) 098202060

(51) Int. Cl. H01Q 1/40

(52) U.S. Cl. 343/873

(57) ABSTRACT

A structure of an antenna is disclosed. The antenna comprises a flexible antenna, a first foam material, a second foam material, a cover plate and a housing. The first foam material and the second foam material together enwrap the flexible antenna. The cover plate and the first foam material match correspondingly. The housing matches with the second foam material, and the housing is joined with the cover plate. The strength of the cover plate and the housing are enhanced respectively by the first and the second foam material to prevent bending and distortion.

### BACKGROUND OF THE INVENTION

1. Field of the Invention

The present invention relates to a structure of an antenna, more particularly to an antenna structure which utilizes foam materials to prevent structural bending.

2. Description of the Related Art

With advancement of technology, Radio Frequency Identification (RFID) is widely used to aid the process of data entry. RFID technology is categorized into Active RFID and Passive RFID. With the aid of RFID technology, data entry for inventory removal or replenishment can be automatically recorded.

In the prior art, the RFID antennas are generally made into an elongated shape in order to comply with the specification of inventory racks, for example, the length of the antenna can be three meters long. However, the lengthy antenna often has a weak structural strength thus causing the shape of the antenna to distort and bend.

Therefore, a new antenna structure is needed to resolve the pitfall of the prior art.

### SUMMARY OF THE INVENTION

The object of the invention is to provide an antenna structure which comprises foam materials to prevent antenna structural distortion.

To achieve the abovementioned objective, the antenna structure of the invention comprises a flexible antenna, a first foam material, a second foam material, a cover plate and a housing. The first foam material and the second foam material together enwrap the flexible antenna. The cover plate and the first foam material match correspondingly. The housing matches with the second foam material, and the housing is joined with the cover plate. The strength of the cover plate and the housing are respectively enhanced by the first and the second foam material to prevent bending and distortion.

The invention has proved to be effective and can be applied in industrial use; therefore a patent application of the invention is filed.

### BRIEF DESCRIPTION OF THE DRAWINGS

FIG. 1 shows the pre-assembly structural diagram of the antenna in accordance with the invention.

FIG. 2 shows the assembled structural diagram of the antenna in accordance with the invention.

FIG. 3 shows the assembly process of the antenna structure in accordance with the invention.

### DETAILED DESCRIPTION OF THE PREFERRED EMBODIMENT

The advantages and innovative features of the invention will become more apparent from the following preferred embodiments.

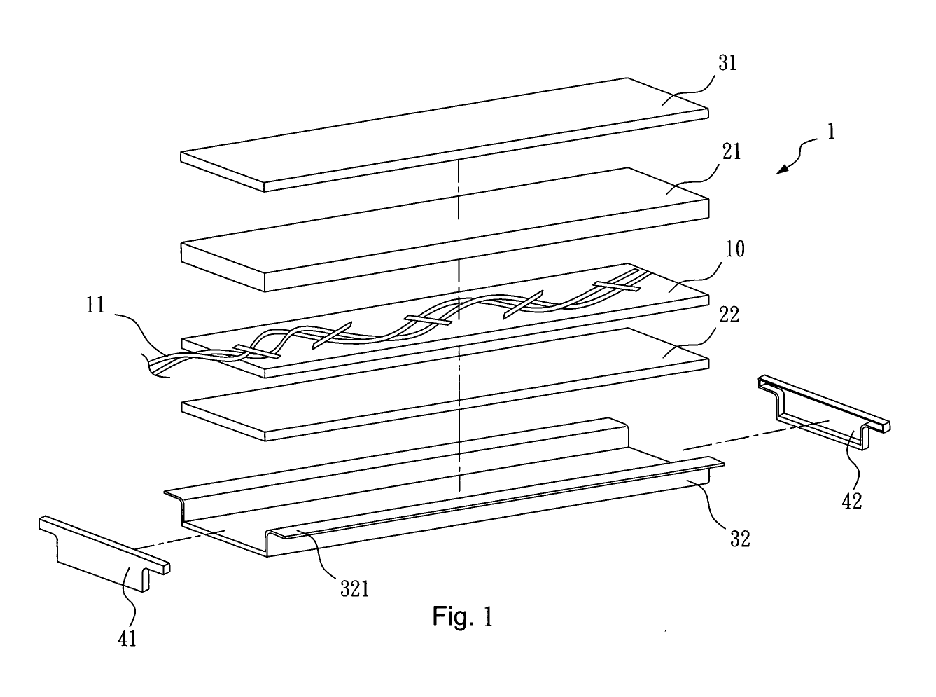

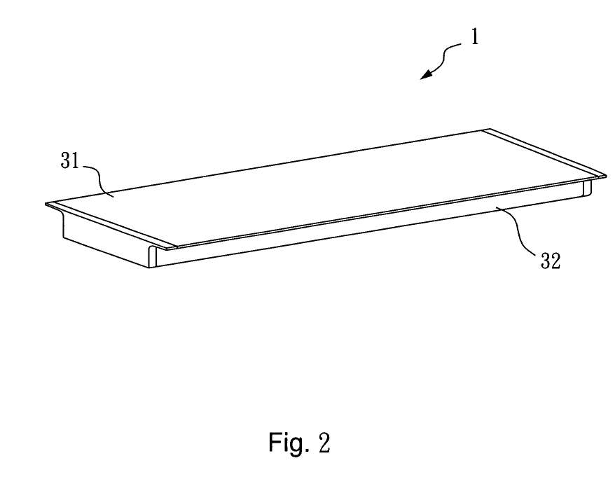

Refer to FIG. 1 and FIG. 2 simultaneously for the antenna structure of the invention. FIG. 1 shows the pre-assembly structural diagram of the antenna in accordance with the invention. FIG. 2 shows the assembled structural diagram of the antenna in accordance with the invention.

An antenna structure 1 of the invention comprises a flexible antenna 10, a first foam material 21, a second foam material 22, a cover plate 31, a housing 32, a front cap 41, and a back cap 42. The flexible antenna 10 is an RFID antenna having a length of approximately three meters. The flexible antenna 10 comprises a cable 11 which is used for linking to the power module and to the control circuit (not shown) to allow for the identification process. The identification process of the RFID antenna is widely used and also well known in the prior art, therefore the principle of the identification process will not be explained further.

The first foam material 21 and the second foam material 22 enwrap the flexible antenna 10. The first foam material 21 and the second foam material 22 can be made of Styrofoam or Polystyrene (PS). In the prefer embodiment of the invention, the first foam material 21 and the second foam material 22 are made from Polystyrene. This design allows the flexible antenna 10 to have a better rate of radiation penetration, and at the same time it is moisture-proof.

The cover plate 31 and the housing 32 can be of plastic units made by compression molding, but the invention is not limited to these materials. The cover plate 31 and the first foam material 21 match correspondingly, and are glued in a way such that the cover plate 31 and the first foam material 21 are adhered together. The cover plate 31 is supported by the first foam material 21 thus preventing distortion or bending when the cover plate 31 is lengthy. Similarly, the housing 32 and the second foam material 22 match correspondingly and are glued together to enhance the supporting strength, thus preventing distortion or bending. The housing 32 comprises a press-fastening part 321. The cover plate 31 is joined to the press-fastening part 321 of the housing 32 by gluing, screwing or hot-air welding. The joining method will be described in more detail.

Lastly, a front cap 41 and a back cap 42 are used to enclose the antenna structure 1 in order to enhance the overall structural strength. The front cap 41 and the back cap 42 have an indentation and a silica gel can be applied to the indentation of the front cap 41 and the back cap 42 for assembling the antenna structure 1. The thickness of the abovementioned antenna structure 1 is approximately 1 cm, which considerably reduces the required implementation space. With the support of the first foam material 21 and the second foam material 22, antenna structure 1 will not bend or deform.

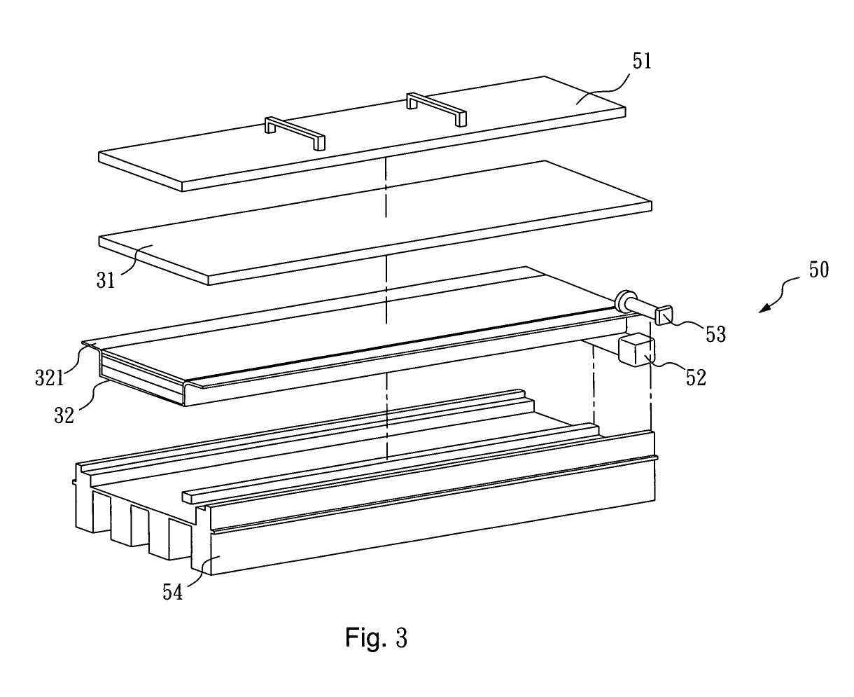

Next, refer to FIG. 3 for the assembly process of the antenna structure in accordance with the invention. The preferred embodiment for joining the cover plate 31 with the housing 32 is through hot-air welding; the joint can also be jointed by applying glue or through screwing, but the invention is not limited to these methods. The hot-air welding technique is shown in FIG. 3. The welding technique is employed by the antenna structure 1 by means of a hot-air welding device 50 to aid the assembly process. The hot-air welding device 50 comprises a platen 51, a hot-air welding apparatus 52, a press roller 53 and a supporting fixture 54. During the hot-air welding process, the antenna structure 1 is placed on top of the supporting fixture 54, and then the platen 51 is pressed onto the cover plate 31 and the housing 32. Next, the press-fastening portion 321 of the housing 32 and the cover plate 31 is secured in between the press roller 53 and the hot-air welding apparatus 52. As a result, the cover plate 31 and the housing 32 are tightly welded together, resulting in an excellent air-tight effect.

Although the invention has been explained in relation to its preferred embodiment, it is to be understood that many other possible modifications and variations can be made without departing from the spirit and scope of the invention as hereinafter claimed.

What is claimed is:

1. An antenna structure comprising:
a flexible antenna;
a first foam material;
a second foam material, wherein the first foam material and the second foam material are used to enwrap the flexible antenna;
a cover plate which matches correspondingly with the first foam material; and
a housing which matches correspondingly with the second foam material; and the housing is joined with the cover plate, wherein strength of the cover plate and the housing is respectively enhanced by the first foam material and the second foam material.

2. The antenna structure as claimed in claim 1, wherein the cover plate and the housing are joined by a hot-air welding technique.

3. The antenna structure as claimed in claim 2, wherein the housing further comprises a press-fastening part, which is used by the housing to press-fasten with the cover plate.

4. The antenna structure as claimed in claim 1, wherein the first foam material and the second foam material are made of Polystyrene.

5. The antenna structure as claimed in claim 1, wherein the first foam material and the second foam material are made of Styrofoam.

6. The antenna structure as claimed in claim 1, wherein a front cap and a back cap are used to enclose the antenna structure.

7. The antenna structure as claimed in claim 6, wherein silica gel is applied to the front cap and the back cap to enclose the antenna structure.

8. The antenna structure as claimed in claim 1, wherein the flexible antenna is a Radio Frequency Identification (RFID) antenna.
